(19) United States
(12) Patent Application Publication
(10) Pub. No.: US 2026/0174069 A1
(43) Pub. Date: Jun. 25, 2026

(54) ILLUMINATION DEVICE FOR FISHING REEL

(71) Applicant: Morgan Hunter Collis, Shepherdstown, WV (US)

(72) Inventor: Morgan Hunter Collis, Shepherdstown, WV (US)

(21) Appl. No.: 19/417,905

(22) Filed: Dec. 12, 2025

Related U.S. Application Data
(60) Provisional application No. 63/737,242, filed on Dec. 20, 2024.

(51) Int. Cl. A01K 87/00

(52) U.S. Cl. CPC A01K 87/008

(57) ABSTRACT

An illumination device for nighttime fishing includes a clip member configured to attach to a fishing rod and a light source mounted to the clip member. When the clip member is attached to the fishing rod, the light source directs focused illumination toward the reel and fishing line, enabling hands-free operation. The clip member may comprise a 3D-printed plastic structure that grips the rod through resilient friction fit. The light source may comprise an LED light or black light adhesively bonded to the clip member. The device provides consistent illumination of the reel area without directing light into the water, avoiding disturbance of fish while allowing the angler to monitor line movement and reel operation with both hands free.

### CROSS-REFERENCE TO RELATED APPLICATION

This application claims the benefit of priority under 35 U.S.C. § 119(e) to U.S. Provisional Ser. No. 63/737,242 , filed Dec. 20, 2024, entitled “Fishing Rod Clip Reel Illuminator,” the entire disclosure of which is hereby incorporated by reference herein.

### FIELD OF THE INVENTION

The present invention relates generally to fishing accessories, and more particularly to an illumination device for providing hands-free lighting of a fishing reel and fishing line during nighttime fishing activities.

### BACKGROUND OF THE INVENTION

Night fishing presents unique challenges for anglers, particularly with respect to visibility of the fishing reel and line. Adequate illumination ca be important for monitoring line movement, detecting bites, and successfully reeling in catches during nighttime conditions.

Conventional solutions for nighttime fishing illumination include handheld flashlights and head-mounted lamps (headlamps). However, each of these approaches has significant drawbacks that diminish the fishing experience and reduce effectiveness.

Handheld flashlights require the angler to occupy one hand with holding and directing the light source. This prevents the angler from using both hands to operate the fishing rod and reel, particularly during the critical moments when reeling in a catch. The angler must either set down the flashlight (losing illumination) or attempt awkward one-handed fishing techniques. Additionally, flashlights are easily misplaced in low-light conditions and require constant repositioning to maintain proper illumination of the reel area.

Headlamps, while providing hands-free operation, suffer from different limitations. Because headlamps are mounted on the user's head, the light beam follows the direction of the user's gaze. This results in inconsistent illumination of the reel, as the light moves away from the target area whenever the angler looks elsewhere. More problematically, headlamps tend to shine directly into the water when the angler looks toward the fishing area, which can startle and scare away fish. The light penetrating the water surface disturbs fish and reduces fishing success. Furthermore, many anglers find headlamps uncomfortable to wear for extended periods.

Neither conventional solution provides focused, directional lighting specifically aimed at the fishing reel while avoiding illumination of the surrounding water. There exists a need for a hands-free illumination solution that maintains consistent lighting of the fishing reel and line without disturbing fish in the water.

### SUMMARY OF THE INVENTION

The present invention addresses the deficiencies of prior art nighttime fishing illumination solutions by providing a clip-mounted illumination device that attaches directly to a fishing rod and directs light specifically toward the fishing reel.

In accordance with one aspect of the present invention, there is provided an illumination device for a fishing rod comprising a clip member configured to attach to a fishing rod, and a light source mounted to the clip member and positioned to direct illumination toward a fishing reel when the clip member is attached to the fishing rod.

The clip member is configured to securely attach to the fishing rod in a position behind the fishing reel, providing stable mounting that prevents movement during use. The light source is oriented to direct a focused beam of light toward the reel, illuminating both the reel mechanism and the fishing line wound on the reel, while avoiding illumination of the surrounding water.

In certain embodiments, the light source comprises an LED light that provides efficient, long-lasting illumination. In some embodiments, the light source comprises a black light (ultraviolet light) that causes fluorescent fishing line to glow brightly, enhancing visibility.

The clip member may be formed from various materials, including molded plastic, 3D-printed plastic, or other suitable materials that provide sufficient structural integrity and resilience for repeated attachment and removal. The clip member may be customized in size and shape to fit different fishing rod diameters and configurations.

The light source is attached to the clip member through various means, including adhesive bonding, mechanical fasteners, or integrated molding. The light source typically includes an integral power source (such as batteries) and a switch for controlling illumination.

The invention provides significant advantages over prior art solutions. The device is completely hands-free, allowing the angler to operate the fishing rod and reel with both hands while maintaining consistent illumination. The light is directed specifically at the reel and line, not into the water, thereby avoiding disturbance of fish. The device remains in a fixed position relative to the reel, providing consistent lighting regardless of head position or movement. The compact, lightweight design does not interfere with normal fishing rod operation.

Other objects, features, and advantages of the present invention will become apparent from the following detailed description, the accompanying drawings, and the appended claims.

### BRIEF DESCRIPTION OF THE DRAWINGS

FIG. 1 is a side perspective view of a fishing rod clip reel illuminator in accordance with the present invention, showing the fishing rod clip reel illuminator in an assembled configuration on a fishing pole;

FIG. 2 is a side elevation view of the fishing rod clip reel illuminator of FIG. 1;

FIG. 3 is a top perspective exploded view of the fishing rod clip reel illuminator;

FIG. 4 is a side view of the fishing rod clip reel illuminator mounted on a fishing rod; and

FIG. 5 is a cross-sectional view taken along line 5-5 of FIG. 4.

### DETAILED DESCRIPTION OF THE INVENTION

The following detailed description presents preferred embodiments of the invention with reference to the accompanying drawings. The embodiments described herein are intended to be illustrative rather than restrictive, and various modifications and alternative configurations will be apparent to those skilled in the art without departing from the scope of the invention as defined by the claims.

### General Structure and Components

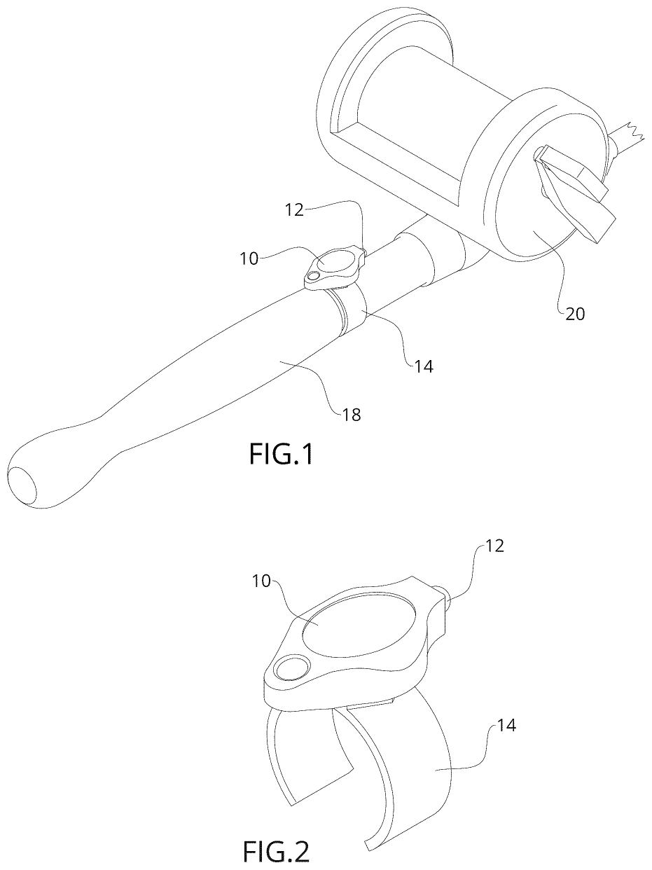

Referring now to FIGS. 1-5, there is shown a fishing rod clip reel illuminator constructed in accordance with a preferred embodiment of the present invention. The device comprises a light source 10 and a clip member 14 configured to attach the light source to a fishing rod 18.

The light source 10 comprises a housing containing a light-emitting element, typically an LED 12, along with a power source such as batteries (not shown) and a control switch (not shown) for activating and deactivating the light. In the preferred embodiment, the light source 10 comprises a compact LED-based flashlight or black light unit that provides focused directional illumination. The LED 12 may emit visible light (such as white light) or ultraviolet light (black light) depending on the application and the type of fishing line being used. Ultraviolet light is particularly effective with fluorescent fishing lines that glow brightly under UV illumination.

The clip member 14 provides a secure attachment mechanism for mounting the light source 10 to the fishing rod 18. The clip member 14 is configured to snap onto or grip the fishing rod 18 with sufficient force to prevent unwanted movement during use, while still allowing for easy attachment and removal when desired. In the preferred embodiment, the clip member 14 comprises a C-shaped or U-shaped structure with resilient arms that can be spread apart to receive the fishing rod 18 and then grip the rod circumference when released.

The clip member 14 may be fabricated from various materials suitable for outdoor use in wet environments. Suitable materials include molded plastics such as ABS, polypropylene, polycarbonate, nylon, or other polymers that provide adequate strength, resilience, and weather resistance. In one particularly advantageous embodiment, the clip member 14 is fabricated using additive manufacturing (3D printing) techniques, which allow for rapid customization of the clip geometry to fit specific fishing rod diameters and configurations. 3D printing also enables cost-effective small-batch production and allows individual anglers to customize the device for their specific equipment.

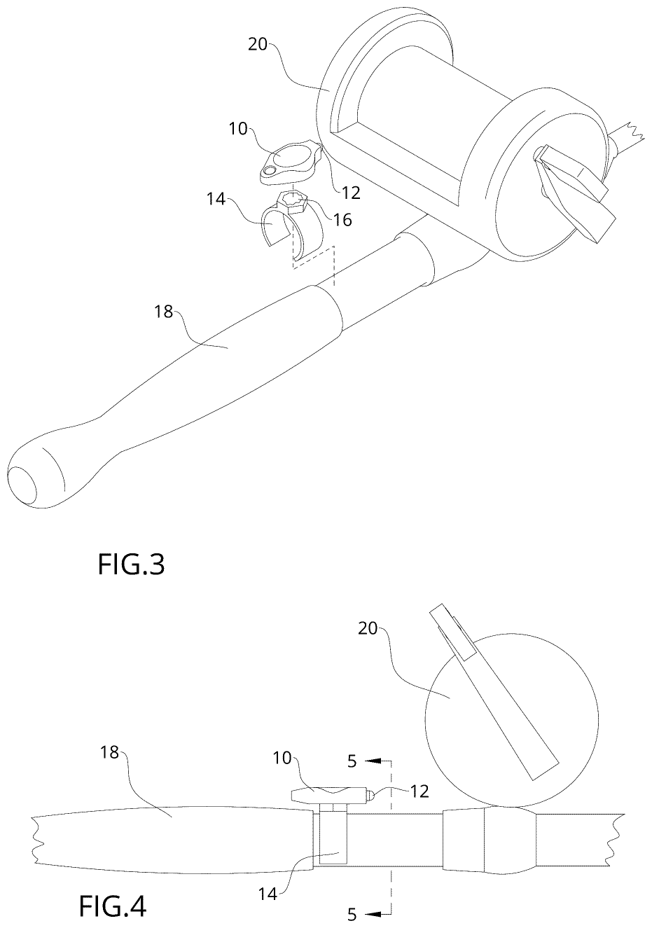

The light source 10 is attached to the clip member 14 by means of an adhesive 16, as shown in FIG. 3, by way of example. Various adhesives may be employed, including epoxy adhesives, cyanoacrylate adhesives, silicone adhesives, or specialized plastic bonding adhesives. The adhesive 16 is applied to create a permanent bond between the light source housing and an upper surface of the clip member 14. After adhesive application, the components are held in contact until the adhesive cures to full strength.

### Operational Configuration

FIGS. 2-4 illustrate the fishing rod clip reel illuminator in its operational configuration, mounted on a fishing rod 18 behind a fishing reel 20. The clip member 14 engages the fishing rod 18 at a location rearward of the reel 20 (toward the handle end of the rod). This positioning places the light source 10 in an optimal position to direct illumination forward toward the reel 20.

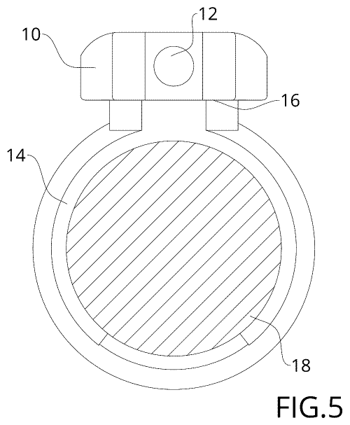

As best shown in FIG. 4, when the clip member 14 is attached to the fishing rod 18, the light source 10 is oriented such that its beam axis is directed toward the fishing reel 20. The light illuminates both the reel mechanism itself and the fishing line wound on the reel spool. This targeted illumination allows the angler to clearly see line movement, reel operation, and line retrieval during nighttime fishing.

The attachment position behind the reel 20 provides several advantages. First, the light source 10 is positioned out of the way of the angler's hands during normal reel operation. Second, the light beam is directed generally parallel to or slightly away from the water surface, minimizing the amount of light that enters the water and potentially disturbs fish. Third, the fixed mounting position ensures consistent illumination regardless of the angler's head position or movement.

While the preferred embodiment positions the clip member 14 behind (rearward of) the reel 20 with the light source 10 facing forward toward the reel, alternative mounting configurations are contemplated within the scope of the invention. In some embodiments, the clip member 14 may be positioned forward of (in front of) the reel 20 with the light source 10 oriented to face rearward toward the reel. This forward mounting position may be advantageous for certain fishing rod configurations or angler preferences.

The clip member 14 may also be positioned on either side of the reel 20 (left or right when viewed from the angler's perspective) depending on rod design and the location of available mounting space. The key functional requirement is that the light source 10 be positioned and oriented to effectively illuminate the reel 20 and line, regardless of whether the device is mounted behind, in front of, or to the side of the reel. The removable nature of the clip member 14 allows the angler to experiment with different mounting positions to determine the optimal configuration for a particular fishing rod and reel combination.

### Method of Use

In operation, the angler attaches the fishing rod clip reel illuminator to the fishing rod 18 by positioning the clip member 14 around the rod at a location behind the reel 20 and allowing the resilient clip to grip the rod surface. The secure friction fit prevents the device from sliding or rotating during use.

Once mounted, the angler activates the light source 10 using the integral control switch. The LED 12 illuminates, directing a focused beam of light toward the reel 20. The angler can then fish normally with both hands free, while the reel area remains continuously illuminated. The angler can monitor line movement, detect bites, and successfully reel in catches with clear visibility of the reel and line.

When fishing is complete, the angler deactivates the light source 10 and removes the device from the fishing rod 18 by spreading the clip member 14 sufficiently to release the rod. The device can be easily reattached for subsequent fishing sessions.

### Alternative Embodiments and Modifications

While the preferred embodiment employs a snap-on clip attachment mechanism, alternative attachment mechanisms are within the scope of the invention. For example, the clip member 14 could incorporate an adjustable strap, a hook-and-loop fastener (such as Velcro), a threaded clamp, or a spring-loaded clip mechanism. Any attachment mechanism that securely mounts the light source 10 to the fishing rod 18 in a position suitable for illuminating the reel 20 may be employed.

The light source 10 may be implemented using various lighting technologies. While LED-based lights are preferred due to their energy efficiency and long life, incandescent bulbs, fluorescent lights, or other light-emitting technologies could be used. The light source 10 may emit light in various spectral ranges, including white light, colored light, or ultraviolet (black) light. The choice of light spectrum may be optimized based on the fishing line being used and ambient lighting conditions.

The method of attachment between the light source 10 and the clip member 14 may vary. While adhesive bonding is described in the preferred embodiment, mechanical attachment means such as screws, clips, snap-fits, or interference fits could be employed. In some embodiments, the light source housing and clip member may be integrally molded as a single piece.

The clip member 14 may be customized in size, shape, and configuration to accommodate different fishing rod diameters and styles. Some fishing rods have cylindrical cross-sections, while others have oval or other non-circular profiles. The clip member 14 can be adapted to properly fit and grip various rod geometries. Multiple sizes of clip members may be provided to fit different rod diameters.

The clip member 14 and light source 10 may be fabricated in various colors. Bright colors enhance visibility and reduce the likelihood of losing the device. Some anglers may prefer subdued colors that are less visually intrusive. The device may be offered in multiple color options to suit different preferences.

In some embodiments, multiple light sources may be mounted to a single clip member, providing redundancy and increased illumination. Alternatively, multiple devices may be mounted at different positions along the fishing rod for specialized applications.

The light source 10 may include additional features such as adjustable brightness, multiple lighting modes (steady, flashing, etc.), or rechargeable batteries. These enhancements may provide added functionality and convenience for some users.

While the invention has been described with reference to specific embodiments, modifications and variations will be apparent to those skilled in the art. All such modifications and variations are intended to be within the scope of the invention as defined by the appended claims.

What is claimed is:

1. An illumination device for a fishing rod, comprising:
a clip member configured to removably attach to a fishing rod; and
a light source mounted to said clip member and oriented to direct illumination toward a fishing reel when said clip member is attached to the fishing rod.

2. The illumination device of claim 1, wherein said light source comprises an LED light.

3. The illumination device of claim 1, wherein said light source comprises a black light configured to emit ultraviolet light.

4. The illumination device of claim 1, wherein said clip member comprises a resilient structure configured to grip the fishing rod through friction fit.

5. The illumination device of claim 1, wherein said clip member comprises a 3D-printed plastic member.

6. The illumination device of claim 1, wherein said light source is adhesively bonded to said clip member.

7. The illumination device of claim 1, wherein said clip member is configured to attach to the fishing rod at a position either forward of or rearward of the fishing reel.

8. The illumination device of claim 1, wherein said light source comprises a housing containing an LED, a power source, and a switch.

9. The illumination device of claim 1, wherein said light source is oriented to direct illumination toward both the fishing reel and fishing line wound on the fishing reel.

10. An illumination device for a fishing rod, comprising:
a clip member comprising a resilient plastic structure configured to grip a fishing rod; and
an LED light source mounted to said clip member by an adhesive, said LED light source oriented to direct a light beam toward a fishing reel when said clip member is attached to the fishing rod.

11. The illumination device of claim 10, wherein said LED light source comprises a black light.

12. The illumination device of claim 10, wherein said clip member comprises a 3D-printed plastic member.

13. The illumination device of claim 10, wherein said clip member is configured to removably attach to the fishing rod without tools.
